(19) United States
(12) Patent Application Publication
(10) Pub. No.: US 2026/0259316 A1
(43) Pub. Date: Sep. 3, 2026

(54) METHODS AND APPARATUS TO GENERATE AZIMUTH-ELEVATION HEATMAPS FOR RADAR DATA

(71) Applicant: Texas Instruments Incorporated, Dallas, TX (US)

(72) Inventors: Akshay Kumar Chandrasekaran, Bangalore (IN); Sandeep Rao, Bangalore (IN); Goutham C Krishnan, Bangalore (IN)

(21) Appl. No.: 19/367,602

(22) Filed: Oct. 23, 2025

(30) Foreign Application Priority Data
Mar. 1, 2025 (IN) 202541018166
Apr. 8, 2025 (IN) 202541034519

(51) Int. Cl. G01S 13/89; G01S 7/41; G01S 13/58

(52) U.S. Cl. CPC G01S 13/89; G01S 7/415; G01S 7/417; G01S 13/584

(57) ABSTRACT

An example apparatus includes radar circuitry to process reflections of transmitted chirp signals to generate radar data; and processor circuitry. In operation, the processor circuitry generates a range-Doppler heatmap of the radar data; generates a plurality of azimuth-elevation heatmaps based on the range-Doppler heatmap; and processes the plurality of azimuth-elevation heatmaps to determine an output azimuth-elevation heatmap.

### RELATED APPLICATIONS

This patent claims the benefit of Indian Provisional Patent Application No. 202541018166, which was filed on Mar. 1, 2025, and Indian Provisional Patent Application No. 202541034519, which was filed on Apr. 8, 2025. Indian Provisional Patent Application No. 202541018166 and Indian Provisional Patent Application No. 202541034519 are hereby incorporated herein by reference in its entirety.

### TECHNICAL FIELD

This description relates generally to radar systems and, more particularly, to methods and apparatus to generate azimuth-elevation heatmaps for radar data.

### BACKGROUND

Radar systems may be utilized in many different environments to detect objects. Such radar systems may include multiple antennas (e.g., transmit antennas and receive antennas). Using the antennas, the radar system transmits chirps that are reflected by an object and received by the radar system. The received data is analyzed to detect the objects.

### SUMMARY

For generating azimuth-elevation heatmaps for radar data, an example apparatus includes radar circuitry configurable to process reflections of transmitted chirp signals to generate radar data. The apparatus includes processor circuitry configurable to generate a range-Doppler heatmap of the radar data, generate a plurality of azimuth-elevation heatmaps based on the range-Doppler heatmap, and process the plurality of azimuth-elevation heatmaps to determine an output azimuth-elevation heatmap. Other examples are described.

For generating azimuth-elevation heatmaps for radar data, a non-transitory computer readable medium includes instructions that perform Fourier transforms, e.g., fast Fourier transforms, on radar data along azimuth and elevation directions to determine a plurality of azimuth-elevation heatmaps; convert values of the plurality of azimuth-elevation heatmaps to magnitudes, and aggregate along dimensions of the plurality of azimuth-elevation heatmaps to generate an output azimuth-elevation heatmap. Other examples are described.

For generating azimuth-elevation heatmaps for radar data an example system is described. The system includes a plurality of antennas including transmit antennas and receive antennas; and radar circuitry coupled to the plurality of antennas. The radar circuitry is configurable to generate radar data. The system further includes memory to store instructions and processor circuitry configurable to execute the instructions to: determine a plurality of range-Doppler representations of the radar data, aggregate the plurality of range-Doppler representations across an antenna dimension to determine a range-Doppler representation, determine range-Doppler indices of select points of the range-Doppler representation, for each of the select points, re-arrange elements of the range-Doppler representation based on a virtual antenna array of the plurality of antennas to form a re-arranged representation having first and second antenna dimensions, for each re-arranged representation, perform a transform operation along the first and second antenna dimensions to generate an azimuth-elevation heatmap for the corresponding select point, and aggregate the azimuth-elevation heat maps to determine an output azimuth-elevation heatmap. Other examples are described.

For generating azimuth-elevation heatmaps for radar data, an example apparatus includes radar circuitry configurable to process reflections of transmitted chirp signals to generate radar data. The apparatus includes processor circuitry configurable to: generate a range-Doppler heatmap of the radar data, generate a plurality of azimuth-elevation heatmaps based on the range-Doppler heatmap, and process the plurality of azimuth-elevation heatmaps to determine an output azimuth-elevation heatmap. Other examples are described.

For generating azimuth-elevation heatmaps for radar data, a non-transitory computer readable medium includes instructions that perform Fourier transforms on radar data along azimuth and elevation directions to determine a plurality of azimuth-elevation heatmaps; convert values of the plurality of azimuth-elevation heatmaps to magnitudes, and aggregate along dimensions of the plurality of azimuth-elevation heatmaps to generate an output azimuth-elevation heatmap. Other examples are described.

For generating azimuth-elevation heatmaps for radar data an example system is described. The system includes a plurality of antennas including transmit antennas and receive antennas and radar circuitry coupled to the plurality of antennas. The radar circuitry is configurable to generate radar data. The system further includes processor circuitry configurable to execute instructions to: determine a plurality of range-Doppler representations of the radar data, aggregate the plurality of range-Doppler representations across an antenna dimension to determine a range-Doppler representation, determine range-Doppler indices of select points of the range-Doppler representation, for each of the select points, re-arrange elements of the range-Doppler representation based on a virtual antenna array of the plurality of antennas to form a re-arranged representation having first and second antenna dimensions, for each re-arranged representation, perform a transform operation along the first and second antenna dimensions to generate an azimuth-elevation heatmap for the corresponding select point, and aggregate the azimuth-elevation heat maps to determine an output azimuth-elevation heatmap. The instructions may be stored in memory and retrieved by the processing circuitry. Other examples are described.

### BRIEF DESCRIPTION OF THE DRAWINGS

FIG. 1 is a block diagram of an example environment in which example detection circuitry operates to analyze sensor data to determine a gesture performed in front of the sensor.

FIG. 2 is a block diagram of an example implementation of a radar circuit.

FIG. 3 includes block diagrams of an example implementations of the training circuitry and the detection circuitry of FIG. 1.

FIGS. 4-5 are flowcharts representative of example machine-readable instructions or example operations that may be at least one of executed, instantiated, or performed using an example programmable circuitry implementation of the training circuitry of FIG. 3.

FIG. 6 illustrates example hand gestures that may be detected by the detection circuitry of FIG. 3.

FIG. 7 is a block diagram of an example processing platform including programmable circuitry structured to execute, instantiate, or perform the example machine-readable instructions or perform the example operations of FIGS. 4-5 to implement the training circuitry and/or detection circuitry of FIG. 3.

The drawings are not necessarily to scale. Generally, the same reference numbers in the drawing(s) and this description refer to the same or similar (functionally and/or structurally) features and/or parts. Although the drawings show regions with clean lines and boundaries, some or all of these lines and boundaries may be idealized. In reality, the boundaries or lines may be unobservable, blended or irregular.

### DETAILED DESCRIPTION

Recent years have seen a reduction in the area, cost and size of mmWave sensors. These sensors are now being considered for a wide variety of consumer applications. One example use is in gesture recognition. Applications include gesture-based human machine interface (HMI) for laptops, phones, earbuds, TVs, thermostats, automotive applications, etc.

Many mmWave radars use frequency modulated continuous waves (FMCW). In an FMCW radar, a sequence of chirps is transmitted in a frame. Signal processing (which is largely Fourier Transform based) is then used to resolve the range, Doppler (relative velocity), and angle of arrival of targets.

In a signal chain that performs gesture recognition, basic signal processing is performed on the received data corresponding to each frame to generate one or more heatmaps (e.g. range-Doppler (RD) heatmap or range-angle heatmap). The heatmaps can be processed, for example, using deep learning to detect a gesture performed in front of the radar. When gestures start getting complex and when gestures are done from a distance (e.g., greater than 2 meters), common feature extraction techniques (e.g., handcrafted features from heatmap) followed by artificial neural network processing may not work. For gesture classification in mmWave radar, handcrafted features extracted from heatmaps along with angle indices calculated from high amplitude points have been analyzed using simple artificial neural networks. However, the use of a range-azimuth heatmap in conjunction with a range-Doppler heatmap has redundant range information and does not take into consideration of angle information in an elevation domain. A range-elevation heatmap could be created and utilized in addition to the range-azimuth heatmap, but this approach would increase the number of inputs to the neural network and would increase computational complexity.

Methods and apparatus disclosed herein create and utilize an azimuth-elevation heatmap. The azimuth-elevation heatmap may exploit information in elevation domain during detection (e.g., gesture detection). In some examples, the azimuth-elevation heatmap may be analyzed by a neural network in conjunction with a range-Doppler heatmap to enable detection of objects (e.g., a gesture) at distances greater than 2 meters. In some examples, the computing requirements of generating the azimuth-elevation heatmap may be minimized by determining the azimuth and elevation using a frequency domain conversion (e.g., Fourier Transform (FT) or fast Fourier Transform (FFT)) that is performed only on a subset of the bins/detected points of a range-Doppler-heatmap. For example, such an approach may reduce the computing from 8192 points down to 20-30 points. In some examples, two heatmaps are analyzed by the neural network, which results in reduced computing as compared with approaches that utilize three heatmaps (e.g., range-Doppler, range-azimuth, and range-elevation).

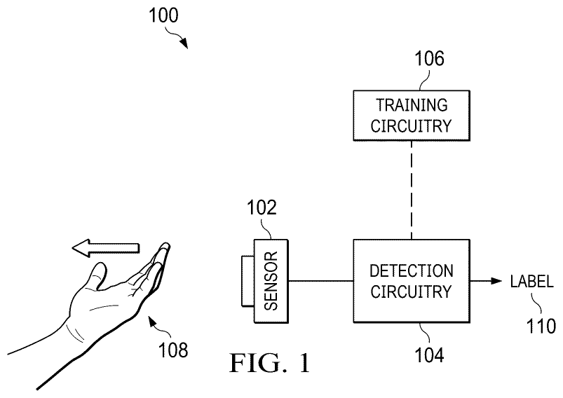

FIG. 1 is a block diagram of an example environment 100 in which an example detection circuitry 104 operates to detect a gesture that is performed in front of a sensor 102. The Environment 100 includes the example sensor 102, the example detection circuitry 104, example training circuitry 106, and an example hand 108 performing a gesture.

The example sensor 102 is radar circuitry. In some examples, the sensor 102 is configurable for millimeter wave radar signals. In other examples, the sensor 102 may be another type of sensor that can detect objects (e.g., a different type of radar sensor, any type of lidar sensor, a camera, or any combination of sensors). The sensor 102 outputs data regarding objects it detects to the detection circuitry 104. For example, the sensor 102 may transmit signals that are reflected from the hand 108 and detected by the sensor 102. Data indicative of the received signals is transmitted by the sensor 102 to the detection circuitry 104.

The detection circuitry 104 analyzes the data received from the sensor 102 to classify objects detected by the sensor 102 and output a label 110. In the illustrated example, the detection circuitry 104 utilizes machine learning (e.g., a deep neural network) to analyze the data from the sensor 102 to detect a hand gesture performed in front of the sensor 102. In particular, the data may be analyzed to determine a range-Doppler heatmap and an azimuth-elevation heatmap, which may be analyzed via a trained neural network to classify the gesture. Alternatively, any other type of analysis may be performed.

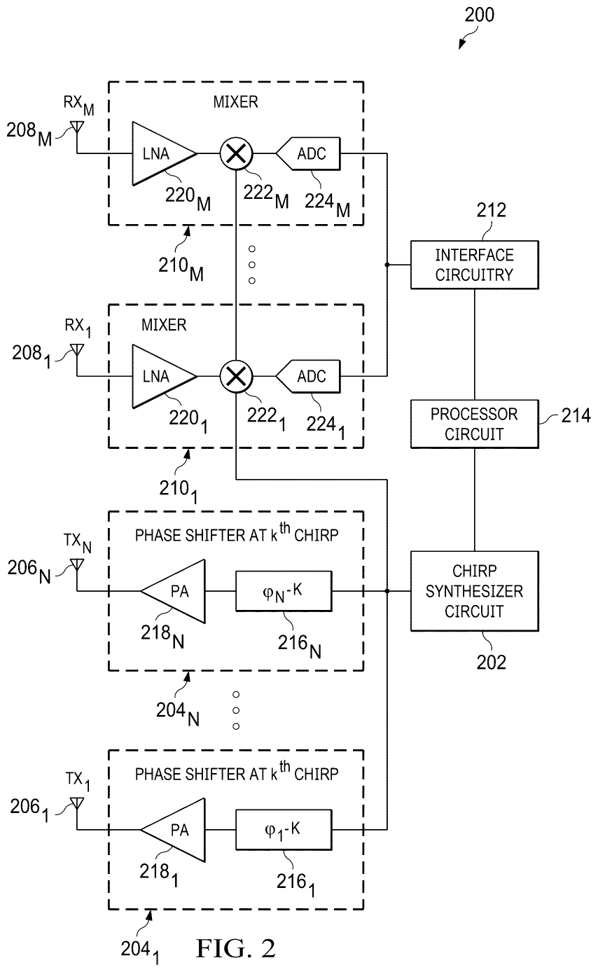

The detection circuitry 104 and the sensor 102 may be integrated into a single circuit. For example, FIG. 2 is a schematic of an example implementation of the sensor 102 and the detection circuitry 104. Alternatively, the sensor 102 and the detection circuitry 104 may be implemented as separate circuits that are communicatively coupled as shown in FIG. 1.

The example detection circuitry 104 uses a machine learning model that is trained by the example training circuitry 106. The example training circuitry 106 is a computing device that collects a plurality of labeled training data from the sensor 102 or other sensors and performs training of a machine learning model. The training circuitry 106 distributes the machine learning model to the detection circuitry 104. In the illustrated example, the trained machine learning model is installed in the detection circuitry 104 prior to deployment of the detection circuitry 104. Alternatively, the trained machine learning model may be distributed to the detection circuitry 104 while the detection circuitry 104 is in the field (e.g., a first trained model or an updated trained model).

While not illustrated in FIG. 1, the label 110 may be transmitted to another system that utilizes the label 110. For example, the label 110 may indicate a hand gesture that was performed and the detected hand gesture may be utilized to control operation of a device (e.g., a vehicle entertainment system).

FIG. 2 is a block diagram of an example implementation of the training circuitry 106 and/or detection circuitry 104 of FIG. 1 to train a machine learning model based on data from the sensor 102 and/or perform classification of an object based on data from the sensor 102. The training circuitry 106 and/or detection circuitry 104 of FIG. 2 may be instantiated (e.g., creating an instance of, bring into being for any length of time, materialize, implement, etc.) by programmable circuitry such as a Central Processor Unit (CPU) executing first instructions, a field programmable gate array, a programmable logic device (PLD), a generic array logic (GAL) device, a programmable array logic (PAL) device, a complex programmable logic device (CPLD), a simple programmable logic device (SPLD), a microcontroller (MCU), a programmable system on chip (PSoC), etc. Also or alternatively, the training circuitry 106 and/or detection circuitry 104 of FIG. 2 may be instantiated (e.g., creating an instance of, bring into being for any length of time, materialize, implement, etc.) by (i) an Application Specific Integrated Circuit (ASIC) or (ii) a Field Programmable Gate Array (FPGA) structured or configured in response to execution of second instructions to perform operations corresponding to the first instructions. Some or all of the circuitry of FIG. 2 may, thus, be instantiated at the same or different times. Some or all of the circuitry of FIG. 2 may be instantiated, for example, in one or more threads executing concurrently on hardware or in series on hardware. Moreover, in some examples, some or all of the circuitry of FIG. 2 may be implemented by microprocessor circuitry executing instructions or FPGA circuitry performing operations to implement one or more virtual machines or containers.

FIG. 2 is a block diagram of an example radar transceiver integrated circuit (IC) 200 that can implement radar sensor 102 of FIG. 1. In the example of FIG. 2, the radar transceiver IC 200, a radar integrated circuit, includes an example chirp synthesizer circuit/circuitry 202, example transmitters 204₁-204_{N}, example transmit antennas 206₁-206_{N}, example receive antennas 208₁-208_{M}, example receivers 210₁-210_{M}, example interface circuit/circuitry 212, and an example processor circuit/circuitry 214. Also, in the example of FIG. 2, the transmitters 204₁-204_{N} include example phase shifters 216₁-216_{N} and example power amplifiers (PAS) 218₁-218_{N}, respectively. The number of receive channels N and the number of transmit channels M may vary depending on the application. Moreover, M and N are not necessarily equal.

In the illustrated example of FIG. 2, the receivers 210₁-210_{M} include example low noise amplifiers (LNAs) 220₁-220_{M}, example mixers 222₁-222_{M}, and example analog-to-digital converters (ADCs) 224₁-224_{M}, respectively. In the example of FIG. 2, the radar transceiver IC 200 includes four of each of the transmitters 204₁-204_{N}, the transmit antennas 206₁-206_{N}, the receive antennas 208₁-208_{M}, and the receivers 210₁-210_{M} (e.g., N equals M equals four). In some examples, the radar transceiver IC 200 includes a different number of any of the transmitters 204₁-204_{N}, the transmit antennas 206₁-206_{N}, the receive antennas 208₁-208_{M}, or the receivers 210₁-210_{M}.

In some examples, the radar transceiver IC 200 and the processor circuit 214 are implemented separately and may be adapted to be coupled together. Also or alternatively, the radar transceiver IC 200 is implemented with the processor circuit 214, for example, in a single chip package or on a SoC (e.g., a single IC). In examples where the radar transceiver IC 200 is implemented with the processor circuit 214 on a SoC, the radar transceiver IC 200 may correspond to a sub-circuit of the IC that forms the SoC.

In modern applications, radar circuits, such as the radar transceiver IC 200 of FIG. 2, include multiple transmitters and multiple receivers. DDMA provides a method to divide a Doppler domain spectrum into multiple sub-divisions and assign each of the multiple transmitters to a respective sub-division. For example, DDMA is widely used in automotive frequency modulated continuous wave (FMCW) radar applications. In DDMA, one or more transmitters transmit a frame of chirps simultaneously where each transmitter imparts a linear phase change (Φ) across the chirps of the frame. For the kth indexed transmitter,

$$\\ {Φ}_{k} = \frac{2 π k}{{N}_{TX}}$$

where N_{TX} is the number of transmitters and k is an index value in a range of [1:N] corresponding to a transmitter that will be transmitting a signal with a phase change Φₖ. As such, the phase changes for the N_{TX} transmitters increase linearly with a direct proportionality to transmitter indices. FMCW results in the domain spectrum that is divided into N_{TX} bands where each target detected by a radar circuit results in N_{TX} peaks or representations and each peak (e.g., image) corresponds to one of the N_{TX} transmitters.

The chirp synthesizer circuit 202 includes functionality to receive chirp parameter values (e.g., from the processor circuit 214) for a sequence of chirps in a radar frame. In some examples, the chirp parameters are defined by the radar system architecture and may include, for example, a transmitter enable parameter for indicating which of the transmitters 204₁-204_{N} to enable, a chirp frequency start value, a chirp frequency slope, an ADC sampling time, a ramp end time, and a transmitter start time, among others. In the example of FIG. 2, the chirp synthesizer circuit 202 also includes functionality to generate signals (e.g., a chirp, a frame of chirps, etc.) for transmission based on the chirp parameter values (e.g., received from the processor circuit 214). In some examples, the chirp synthesizer circuit 202 includes an example oscillator used for the timing of the chirps. The oscillator may include a phase locked loop (PLL) oscillator with a voltage-controlled oscillator (VCO). In additional or alternative examples, the chirp synthesizer circuit 202 includes a local oscillator (LO). As further described below, the processor circuit 214 can adjust frequency and/or frame timing of the oscillator to avoid interference with a radar system of another vehicle.

In the illustrated example of FIG. 2, each of the phase shifters 216₁-216_{N} is implemented by any suitable circuitry. In the example of FIG. 2, each of the phase shifters 216₁-216_{N} is coupled to the chirp synthesizer circuit 202. Also, in the example of FIG. 2, the phase shifters 216₁-216_{N} are coupled to the PAs 218₁-218_{N} (e.g., respective phase shifters are coupled to respective PAs). In the example of FIG. 2, each of the PAs 218₁-218_{N} is implemented by any suitable circuitry. Also, in the example of FIG. 2, the PAs 218₁-218_{N} are coupled to the phase shifters 216₁-216_{N} and the transmit antennas 206₁-206_{N}.

In the illustrated example of FIG. 2, each of the phase shifters 216₁-216_{N} is implemented by any suitable circuitry. In the example of FIG. 2, each of the phase shifters 216₁-216_{N} is coupled to the chirp synthesizer circuit 202. Also, in the example of FIG. 2, the phase shifters 216₁-216_{N} are coupled to the PAs 218₁-218_{N} (e.g., respective phase shifters are coupled to respective PAs). In the example of FIG. 2, each of the PAs 218₁-218_{N} is implemented by any suitable circuitry. Also, in the example of FIG. 2, the PAs 218₁-218_{N} are coupled to the phase shifters 216₁-216_{N} and the transmit antennas 206₁-206_{N}.

In the illustrated example of FIG. 2, each of the phase shifters 216₁-216_{N} receives the output signal provided by the chirp synthesizer circuit 202 (e.g., a chirp, a frame of chirps, etc.) and modulates the output signal provided by the chirp synthesizer circuit 202 to generate a frame of chirps having a linear phase change across chirps. For example, for a first example indexed transmitter 204₁, a first example indexed phase shifter 216₁ applies a first phase change Φ₁ between consecutive chirps of a frame. As such, the first indexed phase shifter 216₁ generates a frame of chirps where the phase changes between consecutive chirps of the frame are equal (e.g., for TX₁ ΔΦ_{C1-C2}=ΔΦ_{C2-C3}=ΔΦ_{C3-C4} . . . =ΔΦ_{C(N-1)-CN}). Also, for example, for an Nth example indexed transmitter 204_{N}, an Nth example indexed phase shifter 216_{N} applies a Nth phase change Φ_{N} between consecutive chirps of a frame. As such, the Nth indexed phase shifter 216_{N} generates a frame of chirps where the phase changes between consecutive chirps of the frame are equal (e.g., for TX_{N} ΔΦ_{C1-C2}=ΔΦ_{C2-C3}=ΔΦ_{C3-C4} . . . =ΔΦ_{C(N-1)-CN}).

The transmitters 204₁-204_{N} transmit frames of chirps simultaneously where each of the transmitters 204₁-204_{N} imparts a phase change (Φ) across the chirps of the frame as described above. In the example of FIG. 2, each of the LNAs 220₁-220_{M} is implemented by any suitable circuitry. In the example of FIG. 2, the LNAs 220₁-220_{M} are coupled to the mixers 222₁-222_{M} and the receive antennas 208₁-208_{M}. Also, each of the mixers 222₁-222_{M} is implemented by any suitable circuitry. In the example of FIG. 2, the mixers 222₁-222_{M} are coupled to the chirp synthesizer circuit 202, the LNAs 220₁-220_{M}, and the ADCs 224₁-224_{M}.

In the illustrated example of FIG. 2, each of the ADCs 224₁-224_{M} is implemented by any suitable circuitry. In the example of FIG. 2, the ADCs 224₁-224_{M} are coupled to the mixers 222₁-222_{M} and the interface circuitry 212. Also, the interface circuitry 212 is implemented by any suitable circuitry. For example, the interface circuitry 212 is implemented according to a communication technique such as a serial interface (e.g., SPI, LVDS interface, etc.), a parallel interface, etc. and is structured to facilitate communication according to the communication technique. In the example of FIG. 2, the interface circuitry 212 is coupled to the ADCs 224₁-224_{M} and the processor circuit 214.

In the illustrated example of FIG. 2, the processor circuit 214 is coupled to the interface circuitry 212 and the chirp synthesizer circuit 202. In the example of FIG. 2, the processor circuit 214 may be implemented by a DSP, a microcontroller, an FFT engine, a combined DSP and microcontroller processor, an FPGA, or an application specific integrated circuit (ASIC).

In the illustrated example of FIG. 2, the processor circuit 214 may be instantiated (e.g., creating an instance of, bring into being for any length of time, materialize, implement, etc.) by programmable circuitry (e.g., at least one programmable circuit) such as a Central Processor Unit (CPU) executing first instructions, an FPGA, a programmable logic device (PLD), a generic array logic (GAL) device, a programmable array logic (PAL) device, a complex programmable logic device (CPLD), a simple programmable logic device (SPLD), a microcontroller unit (MCU), a programmable system on chip (PSoC), etc. Also or alternatively, the processor circuit 214 of FIG. 2 may be instantiated (e.g., creating an instance of, bring into being for any length of time, materialize, implement, etc.) by (i) an ASIC or (ii) an FPGA structured or configured in response to execution of second instructions to perform operations corresponding to the first instructions. Some or all of the processor circuit 214 may, thus, be instantiated at the same or different times. Some or all of the processor circuit 214 may be instantiated, for example, in one or more threads executing concurrently on hardware or in series on hardware. Moreover, in some examples, some or all of the processor circuit 214 may be implemented by microprocessor circuitry executing instructions or FPGA circuitry performing operations to implement one or more virtual machines or containers.

In the illustrated example of FIG. 2, each of the receive antennas 208₁-208_{M} receives signals reflected from an environment in a field of view of the radar transceiver IC 200. For example, each of the receive antennas 208₁-208_{M} receives frames of reflected chirps from the environment. Because the frames of chirps are reflected from the environment, there is a time delay or phase shift between the transmitted frame of chirps and the reflected frame of chirps. In the example of FIG. 2, each of the LNAs 220₁-220_{M} amplifies the received frames of reflected chirps and forwards the amplified received frames to the mixers 222₁-222_{M}. In the example of FIG. 2, each of the mixers 222₁-222_{M} mixes the amplified received frames with the frame of chirps provided by the chirp synthesizer circuit 202 to produce IF received frames of reflected chirps. Also, each of the ADCs 224₁-224_{M} samples the IF received frames of reflected chirps to generate digital samples of the analog signals.

In the illustrated example of FIG. 2, the interface circuitry 212 receives digital samples from the ADCs 224₁-224_{M} and forwards the digital samples to the processor circuit 214 for processing. In the example of FIG. 2, the radar transceiver IC 200 has an R_{MAX} specification where R_{MAX} refers to a maximum range at which the radar transceiver IC 200 can detect a target. The radar transceiver IC 200 implements IF filtering to filter out reflected signals with a delay greater than τ_{MAX} where τ_{MAX} is equal to two R_{MAX} divided by the speed of light

$$( {τ}_{MAX} = \frac{2 * {R}_{MAX}}{c} ) .$$

IF filtering ensures that the signal has a reduced or the minimum bandwidth while allowing signals from targets of interest to be detected and thus helps in minimizing the ADC sampling rate. IF filtering also helps in minimizing interference from other radars.

In some examples, the radar transceiver IC 200 includes digital front end (DFE) circuitry between the ADCs 224₁-224_{M} and the interface circuitry 212. For example, the DFE circuitry receives IF signals from the receivers 210₁-210_{M} and performs decimation filtering or other processing operations on the digital IF signals, for example, to reduce the data transfer rate of the digital IF signals. Also or alternatively, the DFE circuitry performs other operations on the digital IF signals such as direct current (DC) offset removal or compensation (e.g., digital compensation) of non-idealities in the receivers 210₁-210_{M} such as inter-receiver gain imbalance non-ideality, inter-receiver phase imbalance non-ideality, and the like.

In the illustrated example of FIG. 2, the processor circuit 214 receives digital samples representative of a frame of reflected chirps from the interface circuitry 212. In the example of FIG. 2, the processor circuit 214 is structured to perform at least a portion of signal processing on the digital IF signals resulting from a received radar frame. In some examples, the processor circuit 214 is structured to transmit the results of signal processing. For example, the processor circuit 214 transmits the results of signal processing to a processing unit (e.g., the processor circuit 104).

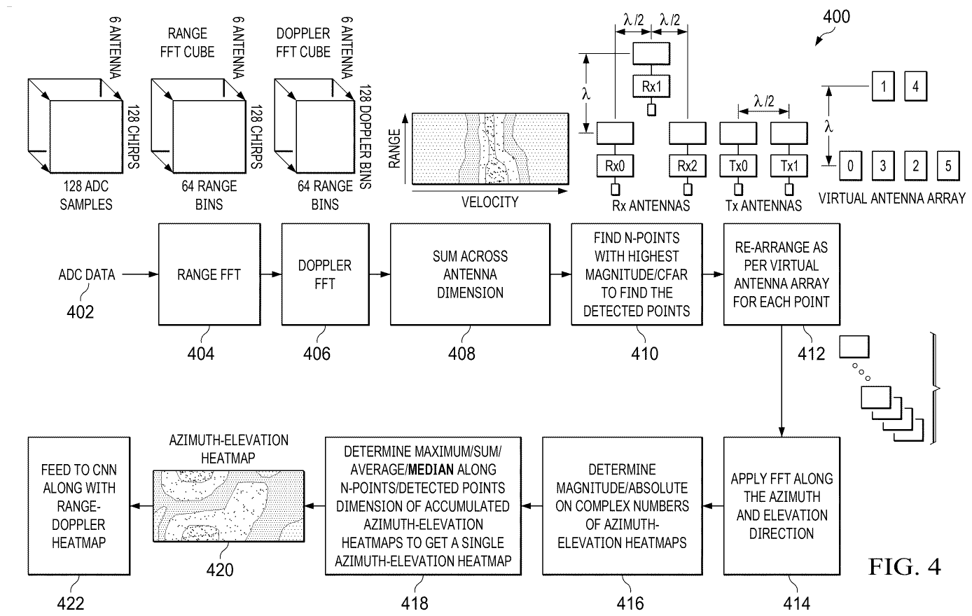

In the illustrated example of FIG. 2, the processor circuit 214 includes functionality to perform a Fourier transform (FT) or fast FT (FFT) on each received frame of reflected chirps. For example, the position of signal power peaks across the range dimension of a range FFT directly corresponds to the distance of a target from the radar transceiver IC 200. In the example of FIG. 2, the processor circuit 214 also includes functionality to perform analysis and FFTs of the radar data to generate range-Doppler heatmaps and azimuth-elevation heatmaps. An example process for determining the heatmaps is described in conjunction with FIG. 4. The processor circuit 214 may be implemented by a general purpose processor, a special purpose processor, discrete circuitry elements, an ASIC, XPU, or FPGA circuitry, or any other circuitry that is structured to perform operations for analysis of radar data.

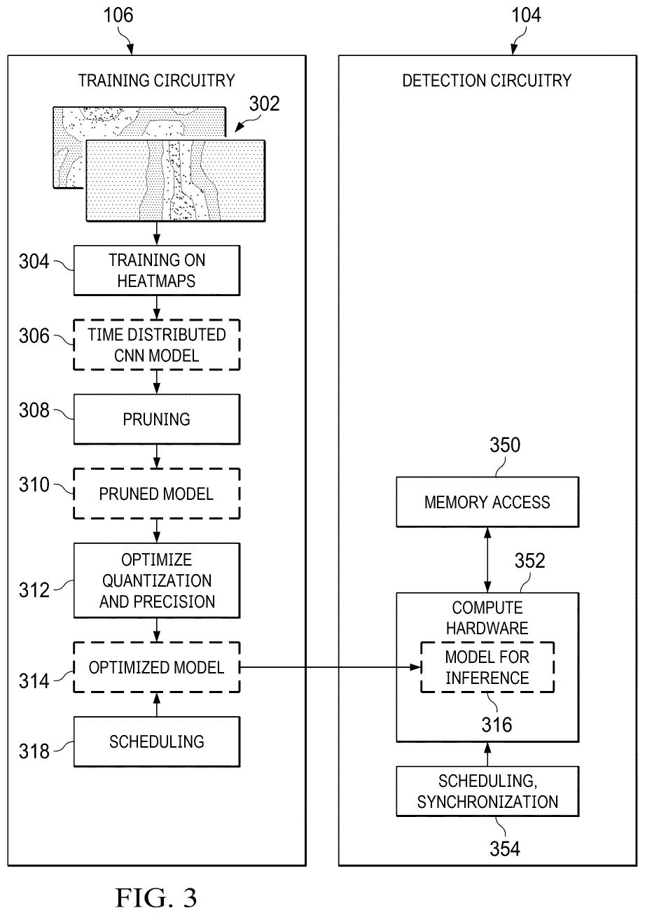

FIG. 3 is a block diagram illustrating an example process for training a model by the training circuitry 106 and analyzing data using the train model by the detection circuitry 104.

The example training circuitry 106 obtains heatmaps 302 (e.g., range-Doppler heatmaps and azimuth-elevation heatmaps that are labeled with corresponding gestures). The training circuitry performs training (block 304) of a time-distributed convolution neural network (CNN) model 306 based on the heatmaps and labels. The training circuitry 106 then performs pruning (block 308) of the weights of the model 306 to eliminate weights that contribute little to the output. Such pruning can make the model 306 smaller and faster to operate. The training circuitry 106 generates a pruned model 310. The training circuitry 106 then performs optimization and quantization (block 312) on the pruned model 310 to generate an optimized model 314. For example, the optimization and quantization (block 312) may include fine-tuning and/or retraining of the model, graph level optimization, quantization to reduce weight precision to shrink model size, etc. The optimized model 314 is transmitted (or otherwise provided) to the detection circuitry 104. The training circuitry 106 may further include scheduling 318 to perform strategic management of computational tasks involved in executing deep neural networks (DNNs) on resource-constrained edge devices. The scheduling 318 may include optimizing how inference tasks use these constrained resources to balance speed, energy consumption, and accuracy.

Turning to the detection circuitry 104, the detection circuitry 104 accesses a memory (block 350) to retrieve the latest model for interference 316 (e.g., optimized model 314 that was previously obtained from the training circuitry 106). Computer hardware 352 processes input data from the sensor 102 using the model for inference 316 to determine a classification of the input data (e.g., a detected gesture). The classification may be output to a device or system that can take action based on the classification. The detection circuitry 104 includes scheduling and synchronization 354 to schedule the instructions for inference based on the timing of received sensor data and needs for the classification result (e.g., to schedule analysis when a device is being operated by a user and other techniques for balancing speed, energy consumption, and accuracy).

FIG. 4 is a block diagram of a process 400 for generating range-Doppler and azimuth-elevation heatmaps. For example, the process 400 may be implemented by machine-readable instructions and/or may be at least one of executed, instantiated, or performed by programmable circuitry to generate the heatmaps (e.g., as part of the training circuitry 106, the detection circuitry 104, and/or a circuit to provide the heatmaps to one or both of the training circuitry 106 and the detection circuitry 104). The example machine-readable instructions and/or the example operations 400 of FIG. 4 begin by obtaining input data 402 after reflection from objects by the sensor 102 (e.g., after the reflected signal is converted from analog to digital). The ADC data 402 includes an array having a first dimension of a number of samples collected (e.g., 128) for a number of chirps sent and detected by the sensor 102 (e.g., 128). The ADC data 402 includes one array for reach antenna (or other element) of the sensor 102 (e.g., 6).

The ADC data 402 is then converted to the frequency domain along the samples (e.g., using an FFT) to generate a range cube 404. The range cube 404 is then converted to the frequency domain along the chirps (e.g., using an FFT) to generate a Doppler cube 406. The Doppler cube 406 is then summed across the antenna dimension to generate a range-Doppler/velocity heatmap 408.

Next, to reduce the computational complexity of processing the range-Doppler heatmap 408 a subset of the points of the heatmap are selected in block 410 and the indices of those points are stored. The subset may be selected by choosing a number N of points that have a highest magnitude, utilizing constant false alarm rate (CFAR) to determine a threshold for selection of points that maintains detection accuracy, or any other technique is reducing the analysis space may be utilized. Then, for each selected point from block 410, the data is re-arranged (block 412) according to the virtual antenna array (e.g., a number of transmit and receive antennas) to map each channel's data to its corresponding virtual antenna element. For example, re-arranging the data may include splitting the received data for each of the transmit antennas and interleaving Tx and Rx combinations to form a virtual antenna array. Re-arranging may include arranging the data as per virtual antenna array pattern (as per antenna design) with value and holes to obtain accurate angle estimates. For example, based on a virtual antenna array, prior to performing FFT in the next operation, the radar data may be rearranged in a 2D array where one dimension is a horizontal antenna dimension and the other dimension is a vertical antenna dimension. according to a virtual antenna array layout and zeros may be added to the data in regions in which there are no antennas.

For each of the N points identified in block 410, an FFT is performed along the horizontal antenna dimension and the vertical antenna dimension to generate N azimuth-elevation heatmaps (block 414). The FFT may be zero-padded (for e.g. in areas where there are no antennas). For each of the N azimuth-elevation heatmaps, the magnitude or absolute value of any complex numbers are determined (block 416). Next, an aggregation (418) is performed across the N azimuth-elevation heatmaps to obtain a single azimuth-elevation heatmap 420. For example, the aggregation may include on or more of maximum, sum, average, median, etc. For example, each element of the single azimuth-elevation heatmap is the maximum/sum/average/median of the corresponding elements of the N azimuth-elevation heatmaps

The resulting azimuth-elevation heatmap 420 is then fed (block 422) to a CNN along with the range-Doppler heatmap 408 to be utilized for classification.

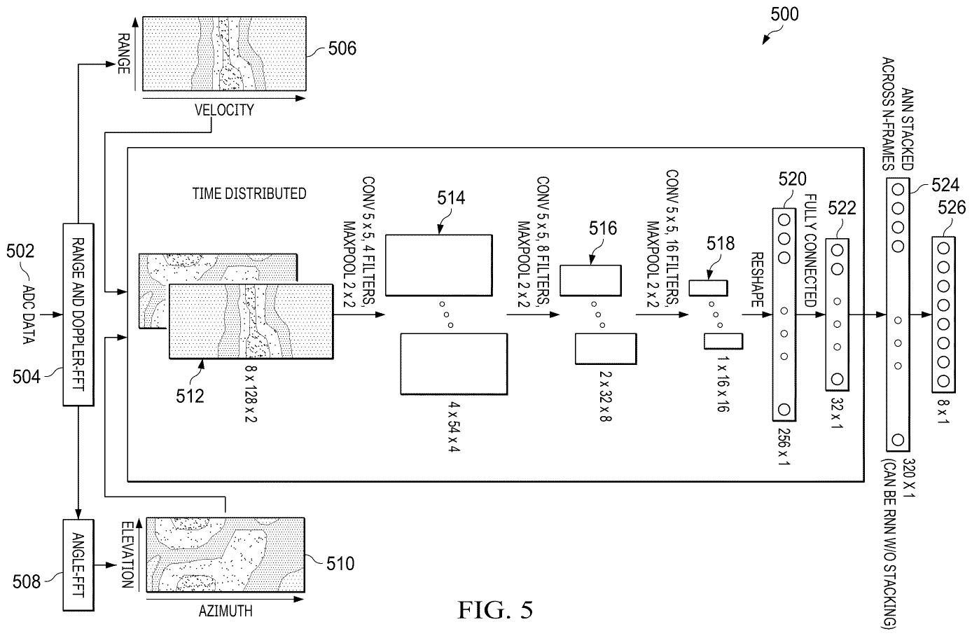

FIG. 5 is a block diagram of an example process 500 to perform classification. For example, the process 500 may be implemented by machine-readable instructions and/or may be at least one of executed, instantiated, or performed by programmable circuitry to perform classification (e.g., by the detection circuitry 104). The example machine-readable instructions and/or the example operations 500 of FIG. 5 begin by obtaining ADC data 502 and performing range and Doppler FFTs (e.g., as described in conjunction with FIG. 4) to generate a range-Doppler heatmap 506. The range-Doppler heatmap 506 is further processed by an angle FFT along the antenna dimensions of azimuth and elevation (block 508) to generate an elevation-azimuth heatmap 510 (e.g., as described in conjunction with FIG. 4).

The range-Doppler heatmap 506 and the elevation-azimuth heatmap 510 are then bundled 512 and convolution is applied (e.g., 5×5 convolution with 4 filters, and 2×2 max pool) to generate resulting arrays 514. A further convolution is performed (e.g., 5×5 convolution with 8 filters and 2×2 max pooling) to generate resulting arrays 516 and another convolution is performed (e.g., 5×5 convolution with 16 filters and 2×2 max pooling) to generate resulting arrays 518. The resulting arrays 518 are then reshaped into a single width array 520 and fed to a fully-connected layer to generate a further resulting array 522. The resulting array 522 is supplied to an artificial neural network (ANN) stacked across N-frames to generate a final array of scores 524. Alternatively, a recurrent neural network (RNN) could be used without stacking.

While an example process for machine learning analysis is illustrated in FIG. 5, other processes that perform classification using azimuth-elevation heatmaps may be utilized (e.g., other types of machine learning, other arrangements of blocks, etc.).

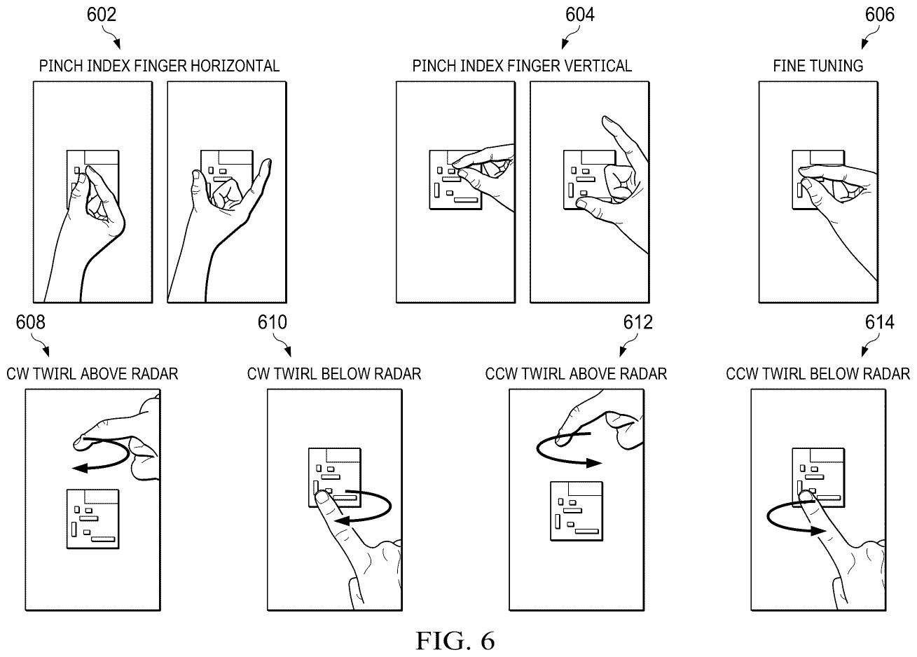

FIG. 6 illustrates example gestures that may be trained by the training circuit 106 and/or detected by the detection circuit 104. For example, 602 illustrates an example horizontal pinch gesture, 604 illustrates an example vertical pinch gesture, 606 illustrates example rubbing fingers together, 608 illustrates a clockwise twirl above the sensor 102, 610 illustrates a clockwise twirl below the sensor 102, 612 illustrates a counter-clockwise twirl above the sensor 102, and 614 illustrates a counter-clockwise twirl below the sensor 102.

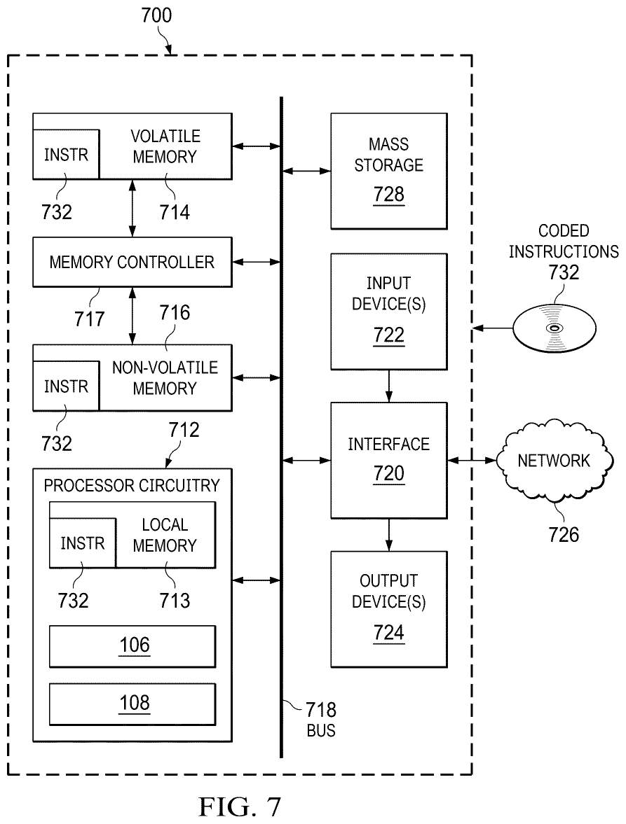

FIG. 7 is a block diagram of an example programmable circuitry platform 700 structured to one or a combination of execute or instantiate one or more of the example machine-readable instructions or the example operations of FIGS. 4-5 to implement the training circuitry and/or detection circuitry of FIG. 3. The programmable circuitry platform 700 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing or electronic device.

The programmable circuitry platform 700 of the illustrated example includes programmable circuitry 712. The programmable circuitry 712 of the illustrated example is hardware. For example, the programmable circuitry 712 can be implemented by one or more integrated circuits, logic circuits, FPGAs, microprocessors, CPUs, GPUs, DSPs, or microcontrollers from any desired family or manufacturer. The programmable circuitry 712 may be implemented by one or more semiconductor based (e.g., silicon based) devices. In this example, the programmable circuitry 712 implements the training circuitry 106 and/or the detection circuitry 104.

The programmable circuitry 712 of the illustrated example includes a local memory 713 (e.g., a cache, registers, etc.). The programmable circuitry 712 of the illustrated example is in communication with main memory 714, 716, which includes a volatile memory 714 and a non-volatile memory 716, by a bus 718. The volatile memory 714 may be implemented by one or more Synchronous Dynamic Random Access Memory (SDRAM), Dynamic Random Access Memory (DRAM), RAMBUS® Dynamic Random Access Memory (RDRAM®), or any other type of RAM device. The non-volatile memory 716 may be implemented by one or a combination of flash memory or any other desired type of memory device. Access to the main memory 714, 716 of the illustrated example is controlled by a memory controller 717. In some examples, the memory controller 717 may be implemented by one or more integrated circuits, logic circuits, microcontrollers from any desired family or manufacturer, or any other type of circuitry to manage the flow of data going to and from the main memory 714, 716.

The programmable circuitry platform 700 of the illustrated example also includes interface circuitry 720. The interface circuitry 720 may be implemented by hardware in according to any type of interface standard, such as an Ethernet interface, a universal serial bus (USB) interface, a Bluetooth® interface, a near field communication (NFC) interface, a Peripheral Component Interconnect (PCI) interface, or a Peripheral Component Interconnect Express (PCIe) interface.

In the illustrated example, one or more input devices 722 are connected to the interface circuitry 720. The input device(s) 722 permit(s) a user (e.g., a human user, a machine user, etc.) to enter one of or a combination of data or commands into the programmable circuitry 712. The input device(s) 722 can be implemented by, for example, one of or a combination of an audio sensor, a microphone, a camera (still or video), a keyboard, a button, a mouse, a touchscreen, a trackpad, a trackball, an isopoint device, or a voice recognition system.

One or more output devices 724 are also connected to the interface circuitry 720 of the illustrated example. The output device(s) 724 can be implemented, for example, by one of or a combination of display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, or speaker. The interface circuitry 720 of the illustrated example, thus, includes one of or a combination of a graphics driver card, a graphics driver chip, or graphics processor circuitry such as a GPU.

The interface circuitry 720 of the illustrated example also includes a communication device such as one of or a combination of a transmitter, a receiver, a transceiver, a modem, a residential gateway, a wireless access point, or a network interface to facilitate exchange of data with external machines (e.g., computing devices of any kind) by a network 726. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 700 of the illustrated example also includes one or more mass storage discs or devices 728 to store one or more of firmware, software, or data. Examples of such mass storage discs or devices 728 include one or more magnetic storage devices (e.g., floppy disk, drives, HDDs, etc.), optical storage devices (e.g., Blu-ray disks, CDs, DVDs, etc.), RAID systems, or solid-state storage discs or devices such as flash memory devices and SSDs.

The machine-readable instructions 732, which may be implemented by the machine-readable instructions of FIGS. 4-5, may be stored in one of or a combination of the mass storage device 728, in the volatile memory 714, in the non-volatile memory 716, or on at least one non-transitory computer readable storage medium such as a CD or DVD which may be removable.

While an example manner of implementing the training circuitry 106 and/or detection circuitry 104 of FIG. 1 is illustrated in FIGS. 3-5, one or more of the elements, processes, or devices illustrated in FIG. 3-5 may be combined, divided, re-arranged, omitted, eliminated, or implemented in any other way. Further, the [the example training circuitry 106 and/or detection circuitry 104 of FIG. 1, may be implemented by hardware alone or by hardware in combination with software and firmware. Thus, for example, the example training circuitry 106 and/or detection circuitry 104, could be implemented by programmable circuitry in combination with one or more machine-readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), or field programmable logic device(s) (FPLD(s)) such as FPGAs. Further still, the example training circuitry 106 and/or detection circuitry 104 of FIG. 1 may include one or more elements, processes, or devices in addition to, or instead of, those illustrated in FIGS. 3-5, or may include more than one of any or all of the illustrated elements, processes and devices.

The machine-readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, or produce machine executable instructions. For example, the machine-readable instructions may be fragmented and stored on one or more storage devices, disks or computing devices (e.g., servers) located at the same or different locations of a network or collection of networks (e.g., in the cloud, in edge devices, etc.). The machine-readable instructions may require one or more of installation, modification, adaptation, updating, combining, supplementing, configuring, decryption, decompression, unpacking, distribution, reassignment, compilation, etc., in order to make them directly readable, interpretable, or executable by a computing device or other machine. For example, the machine-readable instructions may be stored in multiple parts, which are individually compressed, encrypted, or stored on separate computing devices, wherein the parts when decrypted, decompressed, or combined form a set of one or more computer-executable or machine executable instructions that implement one or more functions or operations that may together form a program such as that described herein.

In another example, the machine-readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine-readable instructions may need to be configured (e.g., settings stored, data input, network addresses recorded, etc.) before the machine-readable instructions or the corresponding program(s) can be executed in whole or in part. Thus, machine-readable, computer readable or machine-readable media, as used herein, may include one or a combination of instructions and program(s) regardless of the particular format or state of the machine-readable instructions or program(s).

The machine-readable instructions described herein can be represented by any past, present, or future instruction language, scripting language, programming language, etc. For example, the machine-readable instructions may be represented using any of the following languages: C, C++, Java, C-Sharp, Perl, Python, JavaScript, HyperText Markup Language (HTML), Structured Query Language (SQL), Swift, etc.

As mentioned above, the example operations of FIGS. 4-5 may be implemented using executable instructions (e.g., computer readable and/or machine-readable instructions) stored on one or more non-transitory computer readable or machine-readable media. As used herein, the terms non-transitory computer readable medium, non-transitory computer readable storage medium, non-transitory machine-readable medium, and non-transitory machine-readable storage medium are expressly defined to include any type of computer readable storage device or storage disk and to exclude propagating signals and to exclude transmission media. Examples of such non-transitory computer readable medium, non-transitory computer readable storage medium, non-transitory machine-readable medium, or non-transitory machine-readable storage medium include one or more optical storage devices, magnetic storage devices, an HDD, a flash memory, a read-only memory (ROM), a CD, a DVD, a cache, a RAM of any type, a register, or any other storage device or storage disk in which information is stored for any duration (e.g., for extended time periods, permanently, for brief instances, for temporarily buffering, for caching of the information). As used herein, the terms “non-transitory computer readable storage device” and “non-transitory machine-readable storage device” are defined to include any physical (mechanical, magnetic, electromechanical, or electrical) hardware to retain information for a time period, but to exclude propagating signals and to exclude transmission media. Examples of non-transitory computer readable storage devices or non-transitory machine-readable storage devices include one or a combination of random-access memory of any type, read only memory of any type, solid state memory, flash memory, optical discs, magnetic disks, disk drives, or redundant array of independent disks (RAID) systems. As used herein, the term “device” refers to physical structure such as one of or a combination of mechanical, electromechanical, or electrical equipment, hardware, or circuitry that may or may not be configured by computer readable instructions, machine-readable instructions, etc., or manufactured to execute computer-readable instructions, machine-readable instructions, etc.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and things, the phrase “at least one of A and B” refers to implementations including any of (1) at least one A, (2) at least one B, or (3) at least one A and at least one B. Similarly, as used herein in the context of describing structures, components, items, objects and things, the phrase “at least one of A or B” refers to implementations including any of (1) at least one A, (2) at least one B, or (3) at least one A and at least one B. As used herein in the context of describing the performance or execution of processes, instructions, actions, activities, etc., the phrase “at least one of A and B” refers to implementations including any of (1) at least one A, (2) at least one B, or (3) at least one A and at least one B. Similarly, as used herein in the context of describing the performance or execution of processes, instructions, actions, activities, etc., the phrase “at least one of A or B” refers to implementations including any of (1) at least one A, (2) at least one B, or (3) at least one A and at least one B.

As used herein, singular references (e.g., “a,” “an,” “first,” “second,” etc.) do not exclude a plurality. The term “a” or “an” object, as used herein, refers to one or more of that object. The terms “a” (or “an”), “one or more,” and “at least one” are used interchangeably herein. Furthermore, although individually listed, a plurality of means, elements, or actions may be implemented by, e.g., the same entity or object. Also, although individual features may be included in different examples or claims, these may possibly be combined, and the inclusion in different examples or claims does not imply that a combination of features is at least one of not feasible or advantageous.

As used herein, connection references (e.g., attached, coupled, connected, and joined) may include intermediate members between the elements referenced by at least one of the connection reference or relative movement between those elements unless otherwise indicated. As such, connection references do not necessarily infer that two elements are directly connected or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, or ordering in any way, but are merely used as at least one of labels or arbitrary names to distinguish elements for ease of understanding the described examples. In some examples, the descriptor “first” may be used to refer to an element in the detailed description, while the same element may be referred to in a claim with a different descriptor such as “second” or “third.” In such instances, such descriptors are used merely for identifying those elements distinctly within the context of the discussion (e.g., within a claim) in which the elements might, for example, otherwise share a same name.

As used herein, the phrase “in communication,” including variations thereof, encompasses one of or a combination of direct communication or indirect communication through one or more intermediary components, and does not require direct physical (e.g., wired) communication or constant communication, but rather also includes selective communication at least one of periodic intervals, scheduled intervals, aperiodic intervals, or one-time events.

As used herein, “programmable circuitry” includes (i) one or more special purpose electrical circuits (e.g., an application specific circuit (ASIC)) structured to perform specific operation(s) and including one or more semiconductor-based logic devices (e.g., electrical hardware implemented by one or more transistors), or (ii) one or more general purpose semiconductor-based electrical circuits programmable with instructions to perform one or more specific functions(s) or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations or functions, Field Programmable Gate Arrays (FPGAs) that may be programmed with second instructions to at least one of configure or structure the FPGAs to instantiate one or more operations or functions corresponding to the first instructions, Graphics Processor Units (GPUs) that may execute first instructions to perform one or more operations or functions, Digital Signal Processors (DSPs) that may execute first instructions to perform one or more operations or functions, XPUs, Network Processing Units (NPUs) one or more microcontrollers that may execute first instructions to perform one or more operations or functions or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry includes one or more semiconductor packages containing one or more circuit elements such as transistors, capacitors, inductors, resistors, current paths, diodes, etc. For example, an integrated circuit may be implemented as one or more of an ASIC, an FPGA, a chip, a microchip, programmable circuitry, a semiconductor substrate coupling multiple circuit elements, a system on chip (SoC), etc.

In this description, the term “couple” may cover connections, communications, or signal paths that enable a functional relationship consistent with this description. For example, if device A generates a signal to control device B to perform an action: (a) in a first example, device A is coupled to device B by direct connection; or (b) in a second example, device A is coupled to device B through intervening component C if intervening component C does not alter the functional relationship between device A and device B, such that device B is controlled by device A via the control signal generated by device A.

A device that is “configurable to” perform a task or function may be configured (e.g., at least one of programmed or hardwired) at a time of manufacturing by a manufacturer to at least one of perform the function or be configurable (or re-configurable) by a user after manufacturing to perform the function/or other additional or alternative functions. The configuring may be through at least one of firmware or software programming of the device, through at least one of a construction or layout of hardware components and interconnections of the device, or a combination thereof.

In the description and claims, described “circuitry” may include one or more circuits. A circuit or device that is described herein as including certain components may instead be adapted to be coupled to those components to form the described circuitry or device. For example, a structure described as including one or more semiconductor elements (such as transistors), one or more passive elements (such as one of or a combination of resistors, capacitors, or inductors), or one or more sources (such as voltage and/or current sources) may instead include only the semiconductor elements within a single physical device (e.g., at least one of a semiconductor die or integrated circuit (IC) package) and may be adapted to be coupled to at least some of the passive elements or the sources to form the described structure either at a time of manufacture or after a time of manufacture, for example, by at least one of an end-user or a third-party.

Circuits described herein are reconfigurable to include the replaced components to provide functionality at least partially similar to functionality available prior to the component replacement. Components shown as resistors, unless otherwise stated, are generally representative of any one or more elements coupled in at least one of series or parallel to provide an amount of impedance represented by the shown resistor. For example, a resistor or capacitor shown and described herein as a single component may instead be multiple resistors or capacitors, respectively, coupled in parallel between the same nodes. For example, a resistor or capacitor shown and described herein as a single component may instead be multiple resistors or capacitors, respectively, coupled in series between the same two nodes as the single resistor or capacitor. While certain elements of the described examples are included in an integrated circuit and other elements are external to the integrated circuit, in other example embodiments, additional or fewer features may be incorporated into the integrated circuit. In addition, some or all of the features illustrated as being external to the integrated circuit may be included in the integrated circuit and some features illustrated as being internal to the integrated circuit may be incorporated outside of the integrated. As used herein, the term “integrated circuit” means one or more circuits that are at least one of: (i) incorporated in/over a semiconductor substrate; (ii) incorporated in a single semiconductor package; (iii) incorporated into the same module; or (iv) incorporated in/on the same printed circuit board.

Modifications are possible in the described embodiments, and other embodiments are possible, within the scope of the claims.

While this disclosure has been described with reference to illustrative embodiments, this description is not limiting. Various modifications and combinations of the illustrative embodiments, as well as other embodiments, will be apparent to persons skilled in the art upon reference to the description.

What is claimed is:

1. An apparatus comprising:
radar circuitry configurable to process reflections of transmitted chirp signals to generate radar data; and
processor circuitry configurable to:
generate a range-Doppler heatmap of the radar data;
generate a plurality of azimuth-elevation heatmaps based on the range-Doppler heatmap; and
process the plurality of azimuth-elevation heatmaps to determine an output azimuth-elevation heatmap.

2. The apparatus of claim 1, wherein the processor circuitry is configurable to analyze the output azimuth-elevation heatmap to determine a gesture that was performed.

3. The apparatus of claim 1, wherein, to generate the plurality of azimuth-elevation heatmaps based on the range-Doppler heatmap, the processor circuitry is configurable to determine a plurality of points with highest amplitudes in the range-Doppler heatmap, and generate an azimuth-elevation heatmap for each determined point of the plurality of points.

4. The apparatus of claim 3, further comprising a plurality of transmit antennas to transmit the chirp signals; and a plurality of receive antennas to receive the reflections based on the chirp signals; wherein the plurality of transmit antennas and the plurality of receive antennas form a virtual antenna array, and to generate the azimuth-elevation heatmap for each point of the plurality of points, the processor circuitry is configurable to re-arrange the range-Doppler heatmap per virtual antenna array for each point, and apply transform operations across transmit and receive antenna dimensions of the re-arranged range-Doppler heatmap.

5. The apparatus of claim 4, wherein the processor circuitry is configurable to determine a maximum value along the plurality of azimuth-elevation heatmaps to determine the output azimuth-elevation heatmap.

6. The apparatus of claim 1, wherein the processor circuitry is configurable to analyze the output azimuth-elevation heatmap and the range-Doppler heatmap using a neural network.

7. The apparatus of claim 1, wherein the processor circuitry is configurable to generate the plurality of azimuth-elevation heatmaps based on at least one of identifying a plurality of points with a highest magnitude or identifying points using a constant false alarm rate.

8. The apparatus of claim 1, further comprising receive antennas, wherein, to generate the range-Doppler heatmap, the processor circuitry is configurable to sum range-Doppler representations for the respective receive antennas.

9. A non-transitory computer readable medium comprising instructions that, when executed, cause a processor circuitry to:
perform Fourier transforms on radar data along azimuth and elevation directions to determine a plurality of azimuth-elevation heatmaps;
convert values of the plurality of azimuth-elevation heatmaps to magnitudes; and
aggregate along dimensions of the plurality of azimuth-elevation heatmaps to generate an output azimuth-elevation heatmap.

10. The non-transitory computer readable medium of claim 9, wherein the instructions, when executed, cause the processor circuitry to determine a maximum value along each of the azimuth and elevation dimensions of the plurality of azimuth-elevation heatmaps.

11. The non-transitory computer readable medium of claim 9, wherein the instructions, when executed, cause the processor circuitry to determine a sum value along each of the azimuth and elevation dimensions of the plurality of azimuth-elevation heatmaps.

12. The non-transitory computer readable medium of claim 9, wherein the instructions, when executed, cause the processor circuitry to determine a median value along each of the azimuth and elevation dimensions of the plurality of azimuth-elevation heatmaps.

13. The non-transitory computer readable medium of claim 9, wherein the instructions, when executed, cause the processor circuitry to determine an average value along each of the azimuth and elevation dimensions of the plurality of azimuth-elevation heatmaps.

14. The non-transitory computer readable medium of claim 9, wherein the instructions, when executed, cause the processor circuitry to determine a gesture performed based on the output azimuth-elevation heatmap.

15. The non-transitory computer readable medium of claim 14, wherein the processor circuitry includes a neural network, and the instructions, when executed, cause the processor circuitry to input the output azimuth-elevation heatmap to the neural network, which is configurable to determine the gesture.

16. The non-transitory computer readable medium of claim 15, wherein the instructions, when executed, cause the processor circuitry to generate a range-Doppler heatmap and input the range-Doppler heatmap to the neural network, wherein the neural network is configurable to determine the gesture based on the output azimuth-elevation heatmap and the range-Doppler heatmap.

17. The non-transitory computer readable medium of claim 9, wherein the output azimuth-elevation heatmap is a single heatmap generated for the plurality of azimuth-elevation heatmaps.

18. The non-transitory computer readable medium of claim 9, wherein the instructions, when executed, cause the processor circuitry to generate the plurality of azimuth-elevation heatmaps based on at least one of identifying a plurality of points with a highest magnitude or identifying points using a constant false alarm rate.

19. A system comprising:
a plurality of antennas including transmit antennas and receive antennas;
radar circuitry coupled to the plurality of antennas, the radar circuitry configurable to generate radar data; and
processor circuitry configurable to execute instructions to:
determine a plurality of range-Doppler representations of the radar data;
aggregate the plurality of range-Doppler representations across an antenna dimension to determine a range-Doppler representation;
determine range-Doppler indices of select points of the range-Doppler representation;
for each of the select points, re-arrange elements of the range-Doppler representation based on a virtual antenna array of the plurality of antennas to form a re-arranged representation having first and second antenna dimensions;
for each re-arranged representation, perform a transform operation along the first and second antenna dimensions to generate an azimuth-elevation heatmap for the corresponding select point; and
aggregate the azimuth-elevation heat maps to determine an output azimuth-elevation heatmap.

20. The system of claim 19, wherein the select points are points having a highest magnitude.

21. The system of claim 19, wherein the processor circuitry is configurable to determine a classification of the radar data via a convolutional neural network.

22. The system of claim 21, wherein the classification is an identification of a hand gesture performed in view of the radar circuitry.
